(19) United States
(12) Patent Application Publication
(10) Pub. No.: US 2002/0109475 A1
(43) Pub. Date: Aug. 15, 2002

(54) Variable speed fan motor controlled by a reference voltage

(75) Inventors: Alex Horng, Kaohsiung (TW); Nan Long Tsai, Kaohsiung (TW)

Correspondence Address: Bacon & Thomas, 4th Floor, 625 Slaters Lane, Alexandria, VA, 22314, US

(73) Assignee: Sunonwealth Electric Machine Industry Co., Ltd., Kaohsiung (TW)

(21) Appl. No.: 09/782,023

(22) Filed: Feb. 14, 2001

(51) Int. Cl. H02P 1/04; H02P 3/00; G05B 5/00; H02P 7/00; H02H 7/08; G05D 23/00

(52) U.S. Cl. 318/473

(57) ABSTRACT

A variable speed fan motor controlled by a reference voltage comprises a reference voltage circuit and a differential amplifier. The reference voltage circuit outputs a proper reference voltage that is inputted to a negative terminal of the differential amplifier. When the reference voltage inputted to the negative terminal of the differential amplifier is reduced, a drive voltage outputted by the differential amplifier is increased to thereby increase the speed of the fan. When the reference voltage inputted to the negative terminal of the differential amplifier is increased, the drive voltage outputted by the differential amplifier is reduced to thereby decrease the speed of the fan.

### BACKGROUND OF THE INVENTION

1. Field of the Invention

The present invention relates to a variable speed fan motor controlled by a reference voltage, and more particularly to a fan motor which uses a differential amplifier to calculate a difference between a reference voltage and a power source voltage to thereby output a drive voltage with smooth a waveform for changing the speed of the fan gradually.

2. Description of the Related Art

A conventional fan motor is shown in FIGS. 1 and 2 of the drawings that correspond to FIG. 2 and FIG. 3 of U.S. Pat. No. 5,942,866 to Hsieh issued on Aug. 24, 1999. FIG. 1 is a schematic block diagram of a control circuit. FIG. 2 shows the voltage signal outputted from a switching device of the control circuit. As illustrated in FIG. 1, a control circuit 10 for a DC brushless fan comprises a rectifying circuit 20, a comparator 21, and a switching device 22. The rectifying circuit 20 receives a continuous, rectangular wave signal from the fan 23, which is indicative of the rotating speed of the fan 23, and then sends a rectified and filtered DC voltage signal V1 to inverted input terminal of the comparator 20. The non-inverted input terminal of the comparator 21 is connected to a reference voltage signal Vref, which is used for setting the rotating speed of the fan 23, and the output terminal of the comparator 21 is connected to the switching device 22. The switching device 22 may be a transistor or an equivalent electronic switch that is serially connected between a source voltage Vcc and the source terminal of the fan 23. The operation of the switching device 22 depends on the compared result of the rectified DC voltage signal V1 outputted from the rectifying circuit 21 and the reference voltage signal Vref.

When the DC voltage signal V1 outputted from the rectifying circuit 21 is lower than the reference voltage signal Vref, i.e., the rotating speed of the fan 23 is lower than its setting value, the comparator 21 outputs a Logic high value to the switching device 22. Then, the switching device 22 is closed, and the fan 23 is powered on. Thus, rotating speed of the fan 23 will be increased.

In contrast, when the DC voltage signal outputted from the rectifying circuit 20 is higher than the reference voltage signal Vref, i.e., the rotating speed of the fan 23 is higher than its setting value, the comparator 21 outputs a Logic low value to the switching device 22. Then, the switching device 22 is opened, and the fan 23 is powered off. Thus, rotating speed of the fan 23 will be decreased.

In operation, the switching device 22 is repeatedly closed and opened as the rotating speed of the fan varies, thus the fan is intermittently powered on, whereby the rotating speed of the fan 23 can be controlled and kept at a constant value. As illustrated in FIG. 4, the output signal of the switching device 22 is an intermittently opened and closed rectangular wave, where the period (TIME ON) during which the switching device 22 is closed and the period (TIME OFF) during which the switching device 22 is opened are modulated so as to control the rotating speed of the fan 23.

Nevertheless, the output waveform is an intermittently opened and closed rectangular waveform, and the rotating speed of the fan 23 is increased or decreased suddenly in response to opening or closing of the rectangular waveform or the switching device 22. As a result, the fan wobbles and thus has a shortened longevity.

### SUMMARY OF THE INVENTION

In view of the above drawbacks, the present invention provides a variable speed fan motor controlled by a reference voltage, wherein the fan motor uses a differential amplifier to calculate a difference between a reference voltage outputted by a reference voltage circuit and a power source voltage to thereby output a drive voltage with a smooth waveform for changing the speed of the fan gradually. Thus, sudden change in the fan speed is avoided and the longevity of the fan is lengthened.

Other objects, specific advantages, and novel features of the invention will become more apparent from the following detailed description and preferable embodiments when taken in conjunction with the accompanying drawings.

### BRIEF DESCRIPTION OF THE DRAWINGS

FIG. 1 is a circuit diagram of a conventional controller for a fan.

FIG. 2 is a diagram illustrating the output waveforms for the drive IC of the circuit in FIG. 1.

FIG. 3 is a diagram of a circuit for a fan motor in accordance with the present invention.

FIGS. 4A, 4B, and 4C are schematic views respectively illustrating waveforms of a reference voltage, a fan speed signal, and a drive voltage of the fan motor in accordance with the present invention.

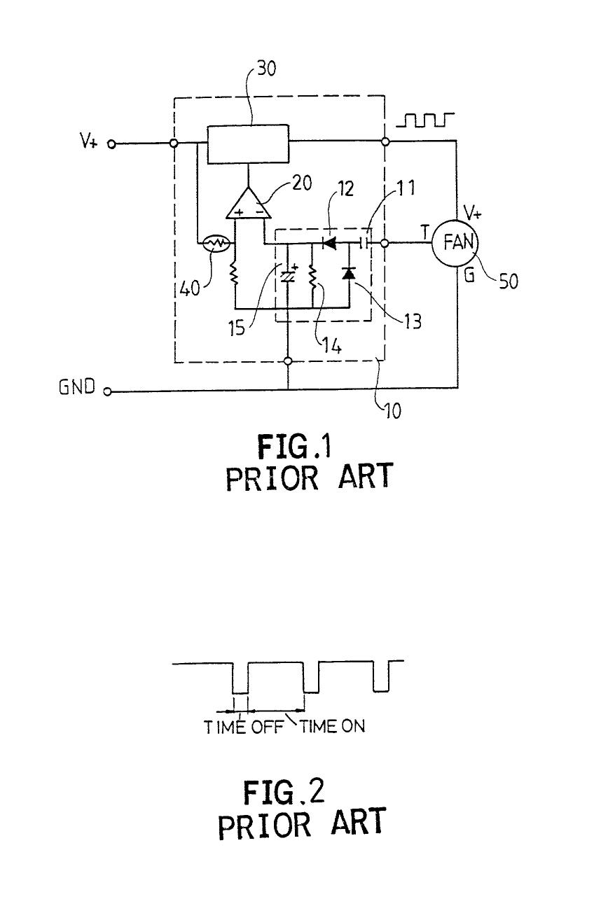

### DETAILED DESCRIPTION OF THE PREFERRED EMBODIMENT

A preferred embodiment in accordance with the present invention will now be described with reference to the accompanying drawings.

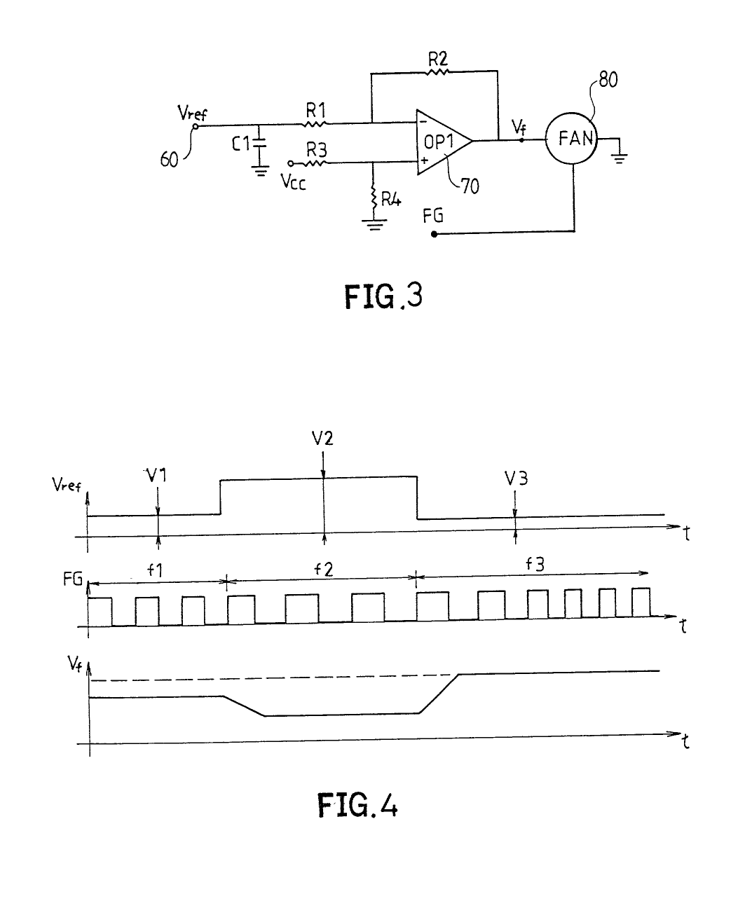

Referring to FIG. 3, a variable speed fan motor controlled by a reference voltage in accordance with the present invention generally includes a reference voltage circuit 60 and a differential amplifier 70. The reference voltage circuit 60 may be a negative temperature coefficient circuit, piezoelectric circuit, or microprocessor system that may output variable reference voltage in response to ambient temperature or system need. In addition, the reference voltage circuit 60 may decide whether to modulate the value of the reference voltage upon consideration of a fan speed signal FG indicating the actual fan speed. When the reference voltage inputted to a negative terminal of the differential amplifier 70 is reduced, a drive voltage outputted by the differential amplifier 70 is increased to thereby increase the speed of the fan. When the reference voltage inputted to the negative terminal of the differential amplifier 70 is increased, the drive voltage outputted by the differential amplifier 70 is reduced to thereby decrease the speed of the fan.

As illustrated in FIG. 3, the differential amplifier 70 is mounted between a fan 80 and a power source Vcc. A negative terminal of the differential amplifier 70 is connected to the reference voltage circuit 60 formed by a negative temperature coefficient circuit, piezoelectric circuit, or microprocessor system, as mentioned above. A positive terminal of the differential amplifier 70 is connected to the power source Vcc. After calculating a difference between the voltage value at the negative terminal and the voltage value at the positive terminal, the differential amplifier 70 outputs a drive voltage Vf that is outputted to a fan 80. In addition, the reference voltage circuit 60 receives an actual speed signal FG detected from the fan 80 to finely modulate the reference voltage Vref to be outputted. After being filtrated and rectified by a capacitor C1 and a resistor R1, the reference voltage Vref is inputted into the negative terminal of the differential amplifier 70. A partial voltage of the power source Vcc is inputted into the positive terminal of the differential amplifier 70. As mentioned above, the differential amplifier 70 calculates a difference between the voltage value at the negative terminal and the voltage value at the positive terminal and outputs a drive voltage Vf for driving the fan 80. It is noted that the drive voltage Vf outputted by the differential amplifier 70 is varied in response to the modulation in the reference voltage Vf.

When the reference voltage Vf inputted to the negative terminal of the differential amplifier 70 is reduced, the drive voltage Vf outputted by the differential amplifier 70 is increased to thereby increase the speed of the fan 80. When the reference voltage Vref inputted to the negative terminal of the differential amplifier 70 is increased, the drive voltage Vf outputted by the differential amplifier 70 is reduced to thereby decrease the speed of the fan 80.

Referring to FIG. 4, waveforms of the outputted drive voltage Vf and the speed signal FG are changed in response to modulation in the reference voltage Vref. When the reference voltage Vref=V1 (the second highest), the differential amplifier 70 outputs a lower drive voltage Vf, and the frequency f1 of the fan speed signal FG is in a second highest state. When the reference voltage Vref is increased from V1 to V2, the differential amplifier 70 outputs a gradually decreasing drive voltage Vf, and the frequency of the fan speed signal FG is gradually decreased from f1 to f2. When the reference voltage Vref is decreased from V2 to V3, the differential amplifier 70 outputs a gradually increasing drive voltage Vf, and the frequency of the fan speed signal is gradually increased from f2 to f3. Thus, when the reference voltage circuit 60 outputs a reference voltage Vref that is finely modulated, the drive voltage Vf outputted by the differential amplifier 70 has a linear smooth waveform to thereby allow gradual increase or decrease in the fan speed.

The drive voltage for the fans disclosed in U.S. Pat. No. 5,942,866 generates rectangular waveforms such that the speed of the fan increases or decreases suddenly. The fan wobbles due to the sudden speed change and the longevity of the fan is shortened. Yet, in the fan motor in accordance with the present invention, the fan motor of the invention outputs a drive voltage Vf that can be varied be means of modulating the reference voltage Vref to control the power source Vcc. The drive voltage Vf has a smooth waveform to allow gradual change in the fan speed. Sudden change in the fan speed is avoided to thereby lengthen longevity of the fan.

Although the invention has been explained in relation to its preferred embodiment as mentioned above, it is to be understood that many other possible modifications and variations can be made without departing from the scope of the invention. It is, therefore, contemplated that the appended claims will cover such modifications and variations that fall within the true scope of the invention.

What is claimed is:

1. A variable speed fan motor controlled by a reference voltage, the fan motor comprising:
a reference voltage circuit for outputting a reference voltage; and
a differential amplifier mounted between a fan and the reference voltage circuit, the differential amplifier including a negative terminal to which the reference voltage is inputted and a positive terminal to which a partial voltage from a power source is inputted;
wherein when the reference voltage outputted by the reference voltage circuit is increased, the drive voltage outputted by the differential amplifier to the fan is reduced gradually to thereby decrease a speed of the fan gradually, and when the reference voltage outputted by the reference voltage circuit is decreased, the drive voltage outputted by the differential amplifier to the fan is induced to thereby increase the speed of the fan gradually.

2. The variable speed fan motor controlled by a reference voltage as claimed in claim 1, wherein the reference voltage circuit is a negative temperature coefficient circuit.

3. The variable speed fan motor controlled by a reference voltage as claimed in claim 1, wherein the reference voltage circuit is a piezoelectric circuit.

4. The variable speed fan motor controlled by a reference voltage as claimed in claim 1, wherein the reference voltage circuit is a microprocessor system.

5. The variable speed fan motor controlled by a reference voltage as claimed in claim 1, wherein the reference is capable of finely modulating a value of the reference voltage by means of using a fan speed signal indicating an actual speed of the fan.
